(19) United States
(12) Patent Application Publication
(10) Pub. No.: US 2015/0192249 A1
(43) Pub. Date: Jul. 9, 2015

(54) EQUIPMENT AND METHOD FOR FILLING PRESSURIZED GAS CYLINDERS FROM A LIQUEFIED GAS TANK

(71) Applicant: L'Air Liquide, Société Anonyme pour I'Etude et I'Exploitation des Procédés Georges Claude, Paris (FR)

(72) Inventors: Philippe Arpentinier, Le Perray en Yvelines (FR); Jean-Paul Barbier, Fourqueux (FR)

(21) Appl. No.: 14/415,331

(22) PCT Filed: Jun. 17, 2013
(86) PCT No.: PCT/FR2013/051408

§ 371 Date: Jan. 16, 2015

(30) Foreign Application Priority Data
Jul. 16, 2012 (FR) 1256835

(51) Int. Cl. F17C 5/06

(52) U.S. Cl. CPC F17C 5/06; F17C 2201/0109; F17C 2221/014; F17C 2223/033; F17C 2223/0161; F17C 2223/046; F17C 2225/0123; F17C 2225/035; F17C 2225/036; F17C 2227/0383; F17C 2227/0346; F17C 2227/0393; F17C 2260/023; F17C 2265/05

(57) ABSTRACT

The invention relates to equipment and method for filling pressurized gas cylinders (7) from a liquefied gas tank (1), including a transfer pipe (10) including an upstream end connected to the tank (1) and at least one downstream end that is to be selectively connected to at least one pressurized gas cylinder (7), the transfer pipe (10) including at least one member (5) for vaporizing the liquid drawn from the tank (1), wherein the equipment includes a member (3) for selectively generating an airflow for exchanging heat with said at least one vaporizing member (5), the equipment being characterized in that it includes an air circuit (4, 8) guiding the air that exchanged heat with the vaporizing member (5) up to a space located at the upstream end of the transfer pipe (10) in order to cool the cylinders (7) to be filled.

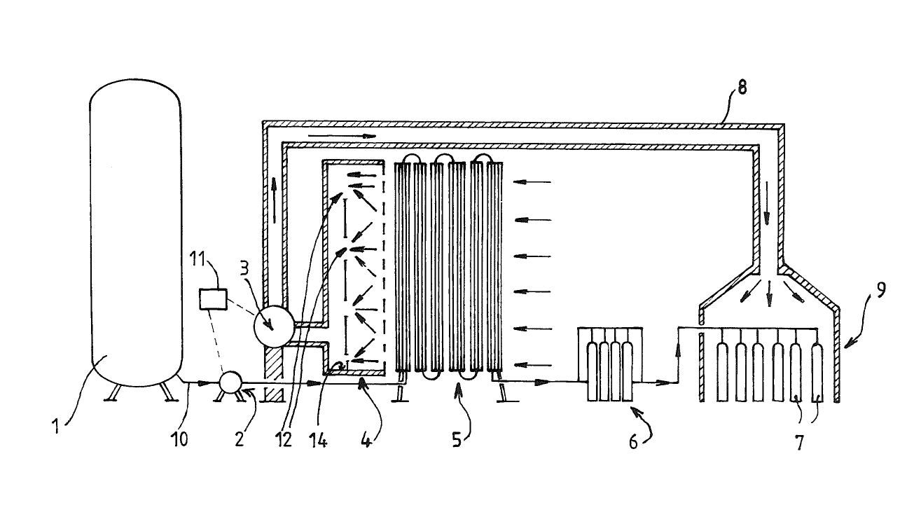

### CROSS REFERENCE TO RELATED APPLICATIONS

This application is a 371 of International PCT Application PCT/FR2013/051408 filed Jun. 17, 2013, which claims priority to French Application FR 1256835 filed Jul. 16, 2012, the entire contents of which are incorporated herein by reference.

### BACKGROUND

The present invention relates to equipment and to a method for filling gas cylinders.

### SUMMARY

The invention relates more specifically to equipment for filling pressurized gas cylinders from a liquefied gas tank, the equipment comprising a transfer pipe which comprises an upstream end which is connected to the tank and at least one downstream end which is intended to be connected selectively to at least one pressurized gas cylinder, the transfer pipe comprising at least one member for vaporizing liquid drawn from the tank, the equipment comprising a member for the selective generation of an air flow in order to exchange heat with the at least one vaporizing member.

Filling compressed gas cylinders produces heat in the cylinders due to the combination of adiabatic expansion and adiabatic compression phenomena.

Said produced heat is dissipated in part by means of the walls of the cylinders. Thus, when filling steel cylinders which have a 50 liter volume with nitrogen gas up to a pressure of 150 bar in 35 minutes (flow rate in the order of 500 kg/hour), if the ambient temperature is 37° C., the final temperature of the cylinders reaches 56° C., being an increase of nearly 20° C.

Said heating process causes increased problems when the cylinders are filled at higher pressures (200 bar, 300 bar or more) in hot environments (ambient temperature in excess of 30° C. or 40° C.).

In effect, during filling the cylinders can reach their maximum safety temperature (for example 70° C. if their taps are equipped with a thermostat fuse). To avoid said problems, one solution consists in cooling the cylinders when they are being filled.

One solution consists in filling the cylinders in an air-conditioned installation. Another solution described in document U.S. Pat. No. 4,556,091 consists in cooling the cylinders using a refrigerant sprayed onto their outside surface. Another solution described in document U.S. Pat. No. 5,934,081 consists in cooling the temperature of the gas introduced into the cylinders.

However, these solutions are unsatisfactory, notably for reasons of the cost of the installation and/or of the consumption of electric power.

One object of the present invention is to remedy all or part of the disadvantages of the prior art stated above.

To this end, the equipment according to the invention, furthermore complying with the generic definition given in the preamble above, is substantially characterized in that it comprises an air circuit which guides the air that has exchanged heat with the vaporizing member up to a space which is situated at the downstream end of the transfer pipe in order to cool the cylinders to be filled.

Furthermore, embodiments of the invention can include one or several of the following characteristics:
the equipment comprises a filling enclosure which delimits a space around the downstream end of the transfer pipe, the enclosure being provided in order to maintain a chilled environment around the cylinders as they are being filled,
the filling enclosure is closed or partially closed,
the filling enclosure is delimited by the walls, at least part of which has a thermally insulating structure,
the air circuit comprises an air manifold which is located so as to be adjacent to the vaporizing member in order to receive the cooled air which has exchanged heat with the member (5) and an air pipe which is connected to the air manifold,
the air manifold comprises a first open end which is adjacent to at least part of the surface of the vaporizing member and a second converging end which is connected to the air manifold,
the equipment comprises a member for starting the equipment which selectively controls the start-up of the filling of the cylinders, the member for starting being connected to the member for the selective generation of an air flow in order to trigger the starting of the member for the selective generation of an air flow in response to a start-up of a filling of the cylinders,
the air manifold comprises a structure which is at least partially thermally insulating,
the vaporizing member comprises a heat exchanger, the first open end of the manifold having a surface which corresponds to the surface of the heat exchanger,
the air circuit is constituted by at least one of the materials amongst: aluminum,
the air manifold is constituted by at least one of the materials amongst: aluminum,
at least part of the air circuit comprises thermally insulated walls,
the liquefied gas tank is a double-wall cryogenic tank with a vacuum between walls,
the transfer pipe comprises at least one pressurized gas buffer storage location which is situated between the vaporizing member and the downstream end of the transfer pipe,
the end of the air circuit which opens out at the cylinders to be filled is diverging,
the air manifold comprises a collecting tray for condensed water,
the air manifold comprises therein buffer volumes and apertures to control the air flow,
the transfer pipe comprises a pump to route in a selective manner the liquid from the tank to the vaporizing member.

The invention can also relate to a method for filling a pressurized gas cylinder or pressurized gas cylinders from a liquefied gas tank in which the liquefied gas is vaporized before being introduced in gaseous form into the cylinder or cylinders, at least part of the frigories produced during the vaporization of the liquefied gas being utilized in order to cool the environment around the cylinders to be filled.

According to other possible particularities:
the frigories are produced in a vaporizing member and are conveyed from the vaporizing member up to the cylinders by means of a forced air flow,
the forced air flow conveying the frigories that are produced in the vaporizing member is created automatically and uniquely during an operation for filling the cylinders.

The invention can also relate to any alternative device or method which comprises any combinations of the characteristics above or below.

### BRIEF DESCRIPTION OF THE DRAWINGS

Other particularities and advantages will appear on reading the description below, given with reference to the sole FIGURE which shows a schematic and part view illustrating a possible but not limiting example of the structure and operation of the filling equipment according to the invention.

### DESCRIPTION OF PREFERRED EMBODIMENTS

The equipment for filling the cylinders 7 which is shown in the FIGURE comprises a tank 1 for pressurized, refrigerated, liquefied gas, for example liquid nitrogen (or another gas depending on the application). Said tank 1, for example, is a cryogenic vacuum-insulated tank storing gas in liquefied refrigerated pressurized form at cryogenic temperatures. The equipment classically comprises a transfer pipe 10 which comprises an upstream end which is connected to the tank 1 and at least one downstream end which is intended to be connected selectively to at least one pressurized gas cylinder 7 which is intended to be filled. The transfer pipe 10 comprises at least one member 5 for vaporizing the liquid withdrawn from the tank 1 such as a liquid/air heat exchanger which ensures the pressurized, refrigerated, liquefied gas is vaporized into compressed gas. As shown, the equipment can include a pump 2 for routing in a selective manner the liquefied gas to the heat exchanger 5, for example at a flow rate of between 250 and 1000 kg/hour inclusive. Downstream of the vaporizing member 5, the transfer pipe 10 can include one or some buffer gas tanks 6. Finally, the downstream end of the transfer pipe 10 is selectively connected to the cylinders 7 to be filled.

According to the invention, the equipment includes a member 3 for the selective generation of an air flow in order to exchange heat with the vaporizing member 5, for example a fan. The equipment also comprises an air circuit 4, 8 which guides the air which has exchanged heat with the vaporizing member 5 up to a space which is situated at the downstream end of the transfer pipe 10 in order to cool a volume around the cylinders 7 to be filled.

The air circuit 4, 8 comprises an air manifold 4 which is situated so as to be adjacent to the vaporizing member 5 in order to receive the air which has exchanged heat with the vaporizing member 5. The air circuit also comprises an air pipe 8 which is connected to the air manifold 4 in order to transport said cooled air to the cylinders 7. Said air manifold 4, in a preferred manner, forms a thermally insulated volume. For example, said manifold 4 forms a box in aluminum or any other appropriate material.

The air manifold 4 comprises in a preferred manner a first open end adjacent to or situated against at least part of the surface of the vaporizing member 5. The air manifold 4 includes a second converging end which is connected to the air pipe 8. The first end of the air manifold 4 has, for example, an open surface which is situated against the vaporizing member 5 and which corresponds in size (height and width) to the surface of said vaporizing member 5. That is to say that all the hot air entering into the vaporizing member 5 from one side is recovered cooled on the other side in the aperture of the air manifold 4.

In its inside volume, in a preferred manner the manifold 4 comprises buffer zones or volumes which are provided with apertures 12 in order to control the air flow therein. Said architecture is provided, for example, in order to standardize the speed of circulation of the cooled air flow and/or in order to limit the turbulence phenomena and/or to maximize the volume of incoming air.

Furthermore, the air manifold 4 can comprise, for example in the bottom part of its inside volume, a collecting tray 14 for condensed water and/or a condensed water removal system.

In a preferred manner the air manifold 4 includes a second converging end which guides the air flow at the inlet of the member for the selective generation of an air flow. Said generating member 3, in a preferred manner, is a fan 3, the outlet of which opens out into the air pipe 8.

The fan 3 can be dimensioned in terms of the size of the equipment and notably in terms of the flow rate of the vaporized fluid, of the need for cooling . . . For example, the fan 3 can be dimensioned to supply a flow rate of 5000 Nm3/hour (normal cubic meters per hour).

Thus, the fan 3 thus draws in warm air and forces it to pass through the vaporizer-exchanger 5 then creates a flow of cooled air in the air pipe 8 which opens out at the space where the cylinders 7 are arranged as they are being filled.

The air pipe 8, in a preferred manner, is a thermally insulated pipe having, for example, a diameter of between 200 mm and 900 mm inclusive and in a preferred manner in the order of 400 mm in order to avoid too large a drop in pressure when transporting the cooled gas.

The downstream end of the air pipe 8 is located in a preferred manner in a closed or partially closed enclosure 9 which accommodates the cylinders 7 during filling, for example a room, the walls of which are thermally insulated

Said end of the air pipe 8 which opens out at the cylinders 7 to be refilled is diverging in a preferred manner and for example located above the cylinders 7.

Said simple and inexpensive architecture allows the cylinders 7 to be cooled in an efficient manner whilst they are being filled without entailing any excessive consumption.

The capacity for cooling of such equipment can be between 20 and 50 KW inclusive.

In a preferred manner, said cooling (starting the fan 3) is only triggered at the moment or just before the cylinders 7 are filled. The starting of the fan 3 can be contingent on the starting of the pump 2 which starts up a filling of the cylinders 7, for example by means of a common starting member (switch for example).

The energy efficiency of such equipment resolves the problems of excessive heating in an advantageous manner since the cooling energy recovered from the vaporizing member 5 is three to four times greater than the heating energy produced in the cylinders during filling. This confirms the advantageous character of such equipment even at a 25% rate of recovery of the frigories produced during vaporization of the liquefied gas.

The equipment requires limited investment and a smaller electricity consumption than the known solutions.

Said equipment is particularly advantageous for filling pressurized gas cylinders (nitrogen or another gas or a mixture) at 200 bar, 300 bar or above in geographical areas where the ambient temperature is relatively high (30° C. or more).

The equipment can notably utilize a vaporizing member which comprises an ambient vaporizer using available forced air ventilation. For example, said ambient vaporizer can be of the type sold by Thermax Inc. under the reference “CD 50 HF”. Said ambient vaporizer comprises forced air ventilation. The outlet of the forced air ventilation of said vaporizer can be connected, by means of a duct which in a preferred manner is thermally insulated, to the downstream end of the transfer pipe, that is to say at the site of the cylinders 7 to be filled in the enclosure 9. In a preferred manner, said forced ventilation air opens out into the enclosure above the downstream end of the transfer pipe, that is to say above the site provided for the cylinders to be filled in the enclosure 9.

Also in a preferred manner, and as described above, the equipment operates automatically: the forced air ventilation starts up automatically as soon as the cryogenic fluid is vaporized.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1-12. (canceled)

13. An apparatus for filling pressurized gas cylinders including a liquefied gas tank comprising; a transfer pipe comprising an upstream end connected to the tank and at least one downstream end configured to connect selectively to at least one pressurized gas cylinder, the transfer pipe comprising at least one member for vaporizing liquid drawn from the tank, the equipment comprising a member for the selective generation of an air flow in order to exchange heat with the at least one vaporizing member, an air circuit which guides the air that has exchanged heat with the vaporizing member to a space situated at the downstream end of the transfer pipe in order to cool the cylinders to be filled, a filling enclosure which delimits a space around the downstream end of the transfer pipe, the maintaining a chilled environment around the downstream end of the transfer pipe, the air circuit comprising an air manifold, adjacent to the vaporizing member in order to receive the cooled air which has exchanged heat with the member, and an air pipe, with an upstream end is connected to the air manifold and a downstream end situated in the enclosure.

14. The apparatus of claim 13, wherein the filling enclosure is closed or partially closed.

15. The apparatus of claim 13, wherein the filling enclosure is delimited by the walls, at least part of which has a thermally insulating structure.

16. The apparatus of claim 13, wherein the air manifold comprises a first open end which is adjacent to at least part of the surface of the vaporizing member and a second converging end which is connected to the air pipe.

17. The apparatus of claim 16, wherein the vaporizing member comprises a heat exchanger, the first open end of the manifold having a surface which corresponds to the surface of the exchanger.

18. The apparatus of claim 13, further comprising a member for starting the equipment which selectively controls the start-up of the filling of the cylinders and in that the member for starting is connected to the member for the selective generation of an air flow in order to trigger the starting of the member for the selective generation of an air flow in response to a start-up of a filling of the cylinders.

19. The apparatus of claim 13, wherein the transfer pipe comprises at least one pressurized gas buffer storage location which is situated between the vaporizing member and the downstream end of the transfer pipe.

20. The apparatus of claim 13, wherein the end of the air circuit is diverging.

21. The apparatus of claim 13, wherein the vaporizing member comprises a liquid/air heat exchanger.

22. The apparatus of claim 13, wherein the downstream end of the air pipe opens out in the top part of the enclosure.

23. A method for filling a pressurized gas cylinder or pressurized gas cylinders from a liquefied gas tank in which the liquefied gas is vaporized before being introduced in gaseous form into the cylinder or cylinders, wherein at least part of the cooling is produced during the vaporization of the liquefied gas is utilized in order to cool the environment around the cylinders to be filled, the cooling being produced in a vaporizing member and being transferred into the air and in that said cooled air is conveyed by means of an air flow which is forced from the vaporizing member as far as into the enclosure protecting the cylinders by means of a forced air flow.

24. The method of claim 23, wherein the forced air flow which conveys the cooling that are produced in the vaporizing member is created automatically and uniquely during an operation for filling the cylinders.
